(19) United States
(12) Patent Application Publication
(10) Pub. No.: US 2026/0011861 A1
(43) Pub. Date: Jan. 8, 2026

(54) POWER STORAGE DEVICE AND SYSTEM

(71) Applicant: TOYOTA JIDOSHA KABUSHIKI KAISHA, Aichi-ken (JP)

(72) Inventors: Akio UOTANI, Nagoya-shi (JP); Dexu ZHANG, Mishima-shi (JP); Yoshinobu KUROYAMA, Aichi-gun (JP); Daisuke KAMESAKI, Okazaki-shi (JP); Seigo FUJISHIMA, Miyoshi-shi (JP); Yuki TAKAHASHI, Miyoshi-shi (JP)

(21) Appl. No.: 19/070,523

(22) Filed: Mar. 5, 2025

(30) Foreign Application Priority Data
Jul. 4, 2024 (JP) 2024-108205

(51) Int. Cl. H01M 50/342; H01M 10/48; H01M 50/249; H01M 50/289; H01M 50/367; H01M 50/581

(52) U.S. Cl. CPC H01M 50/3425; H01M 10/48; H01M 50/249; H01M 50/289; H01M 50/367; H01M 50/581; H01M 2200/103

(57) ABSTRACT

The power storage device includes a housing having a frame member and a power storage unit (power storage module) housed in the housing. The frame member is provided with an exhaust path that guides the gas discharged from the power storage unit to the outside of the housing. The exhaust path is provided with a blocking member (detection member) that blocks the exhaust path. The blocking member is configured to be broken by a pressure increase due to the gas discharged from the power storage unit.

### CROSS-REFERENCE TO RELATED APPLICATION

This application claims priority to Japanese Patent Application No. 2024-108205 filed on Jul. 4, 2024. The disclosure of the above-identified application, including the specification, drawings, and claims, is incorporated by reference herein in its entirety.

### BACKGROUND

### 1. Technical Field

The present disclosure relates to a power storage device and a system.

### 2. Description of Related Art

Japanese Unexamined Patent Application Publication No. 2019-219173 (JP 2019-219173 A) discloses a temperature sensor (exhaust gas temperature sensor) that detects a temperature of a gas discharged from a battery (power storage unit).

### SUMMARY

The temperature sensor described in JP 2019-219173 A is used, for example, to control an exhaust valve provided in an exhaust path. For example, a configuration in which the exhaust valve is opened in a case where a high-temperature and high-pressure gas in the exhaust path is detected by the temperature sensor is considered. However, since the temperature sensor is placed in a severe environment, the temperature sensor is likely to fail. In addition, a temperature sensor having high accuracy and high durability is expensive.

The present disclosure has been made to solve the above problems, and an object of the present disclosure is to provide a power storage device and a system capable of more reliably opening an exhaust path at a time of generation of a high-temperature and high-pressure gas.

A power storage device according to a first aspect of the present disclosure includes a housing including a frame member and a power storage unit housed in the housing. An exhaust path configured to guide a gas discharged from the power storage unit to an outside of the housing is provided in the frame member. The exhaust path is provided with a blocking member configured to block the exhaust path. The blocking member is configured to be broken by an increase in a pressure due to the gas discharged from the power storage unit.

A system according to a second aspect of the present disclosure includes the power storage device and a control device. The control device is configured to determine whether a high-temperature and high-pressure gas is generated in a space blocked by the blocking member based on whether the blocking member is broken.

According to the present disclosure, it is possible to provide a power storage device and a system capable of more reliably opening an exhaust path at a time of generation of a high-temperature and high-pressure gas.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a schematic configuration of a vehicle according to an embodiment of the present disclosure;

FIG. 2 is a cross-sectional view showing a lower structure of the vehicle shown in FIG. 1;

FIG. 3 is an exploded perspective view of the power storage device shown in FIG. 2;

FIG. 4 is a diagram showing an example of a wiring aspect of the power storage device shown in FIG. 3;

FIG. 5 is a diagram showing an example of a structure of the detection member shown in FIG. 4; and

FIG. 6 is a diagram showing a system according to the embodiment of the present disclosure.

### DETAILED DESCRIPTION OF EMBODIMENTS

An embodiment of the present disclosure will be described in detail with reference to the drawings. In the drawings, the same or corresponding parts are denoted by the same reference numerals, and the description thereof will not be repeated. In each of the drawings used below, among the X-axis, the Y-axis, and the Z-axis that are orthogonal to each other, the Z-axis indicates the height direction of the power storage device. Hereinafter, the direction indicated by the arrow of the X-axis, the Y-axis, and the Z-axis is represented by “+”, and the opposite direction is represented by “−”. The −Z direction corresponds to the vertical downward (direction of gravity).

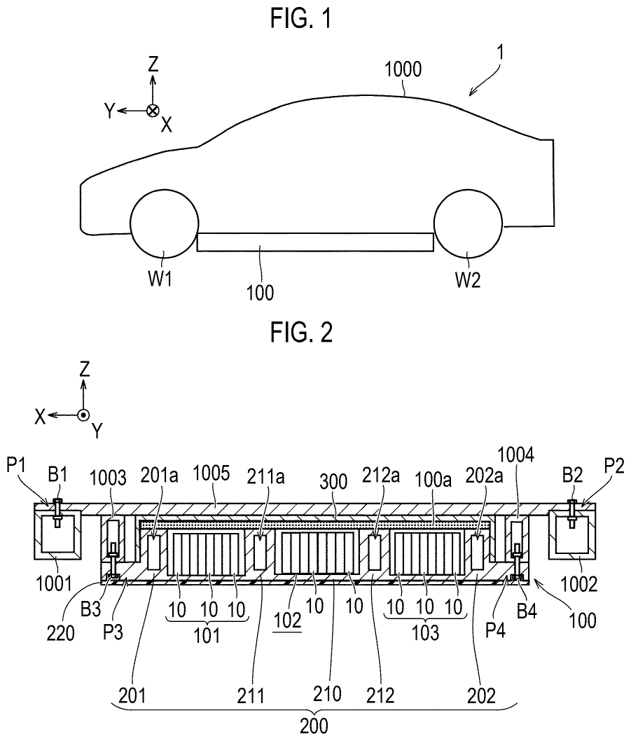

FIG. 1 is a diagram showing a schematic configuration of a vehicle 1 according to the present embodiment. FIG. 2 is a cross-sectional view showing a lower structure of the vehicle 1. The vehicle 1 includes a power storage device 100 shown in FIGS. 1 and 2, and is configured to be able to travel using power output from the power storage device 100. The vehicle 1 is, for example, a battery electric vehicle (BEV) that does not include an internal combustion engine. It should be noted that the present disclosure is not limited to this, and the power storage device 100 may be mounted on a plug-in hybrid electric vehicle (PHEV) including an internal combustion engine. In addition, the power storage device 100 may be mounted on another electrified vehicle (xEV).

The vehicle 1 further includes a vehicle body 1000 (body) and front wheels W1 and rear wheels W2. The vehicle body 1000 includes a front portion, a side skeleton, a floor, a roof, and a rear portion. As shown in FIG. 2, the side skeleton of the vehicle body 1000 includes a pair of side sills 1001, 1002 and a pair of side members 1003, 1004. A pair of side sills 1001, 1002 corresponds to both end portions of the vehicle 1 in a width direction (X direction). The side members 1003, 1004 are positioned near the inside of the side sills 1001, 1002, respectively. Each of the side sills 1001, 1002 and the side members 1003, 1004 is formed to be long in the front-rear direction (Y direction) of the vehicle 1.

The floor of the vehicle body 1000 includes a cross member 1005 shown in FIG. 2. The cross member 1005 is formed to be long in the width direction (X direction) of the vehicle 1. An end portion P1 of the cross member 1005 on the +X side is fixed to the side sill 1001 by a fastening member B1 (for example, a bolt and a nut). An end portion P2 of the cross member 1005 on the −X side is fixed to the side sill 1002 by a fastening member B2 (for example, a bolt and a nut).

The power storage device 100 is disposed, for example, between the front wheels W1 and the rear wheels W2 in the front-rear direction (Y direction) of the vehicle 1. In the present embodiment, the power storage device 100 is positioned under the floor of the vehicle 1 as shown in FIGS. 1 and 2. Specifically, in the width direction (X direction) of the vehicle 1, the center portion (including the power storage unit) of the power storage device 100 is disposed between the side members 1003, 1004. Therefore, the power storage device 100 is protected by the side members 1003, 1004. The side members 1003, 1004 may be connected to the side sills 1001, 1002 via energy absorption (EA) members (not shown). An upper surface (a surface on the +Z side) of the power storage device 100 may be fixed to a lower surface (a surface on the −Z side) of the floor of the vehicle body 1000. The power storage device 100 may be fixed to the cross member 1005. An upper surface of the power storage device 100 may function as a floor (floor of the vehicle body 1000) of the vehicle cabin.

The power storage device 100 includes a plurality of power storage modules (including power storage modules 101 to 103 shown in FIG. 2) and a housing that houses the power storage modules. Each power storage module includes a plurality of power storage cells 10. In the present embodiment, an example in which the number of power storage cells 10 in each power storage module is eight is shown. However, the number of the power storage cells 10 can be appropriately changed.

The housing of the power storage device 100 includes a lower (LWR) case 200 and an upper (UPR) case 300. The LWR case 200 includes a plate-shaped bottom portion 210, a plurality of frame members (including the frame members 201, 202, 211, 212 shown in FIG. 2), a +X-side end portion P3, a −X-side end portion P4, and an undercover 220. The details will be described later, but an exhaust path (for example, a passage for exhaust gas) through which the gas flows is formed in the inside of each frame member. For example, the frame members 201, 202, 211, 212 shown in FIG. 2 are provided with exhaust paths 201a, 202a, 211a, 212a, respectively. The undercover 220 is riveted to, for example, a lower surface (a surface on the −Z side) of the bottom portion 210. The undercover 220 is formed of, for example, a fiber reinforced plastic (FRP). The end portion P3 is fixed to the side member 1003 by a fastening member B3 (for example, a bolt and a nut). The end portion P4 is fixed to the side member 1004 by a fastening member B4 (for example, a bolt and a nut).

The housing of the power storage device 100 further houses the component 100a. The component 100a is positioned between the UPR case 300 and each power storage module. The component 100a includes, for example, a cooling plate. The cooling plate functions as a liquid cooling type cooler, for example. The component 100a may further include a wire (for example, a bus bar) that electrically connects the power storage modules, a temperature sensor (for example, a thermistor) that detects at least one temperature of the power storage module, and at least one of an insulating sheet, an impact absorbing material, and a heat conductor.

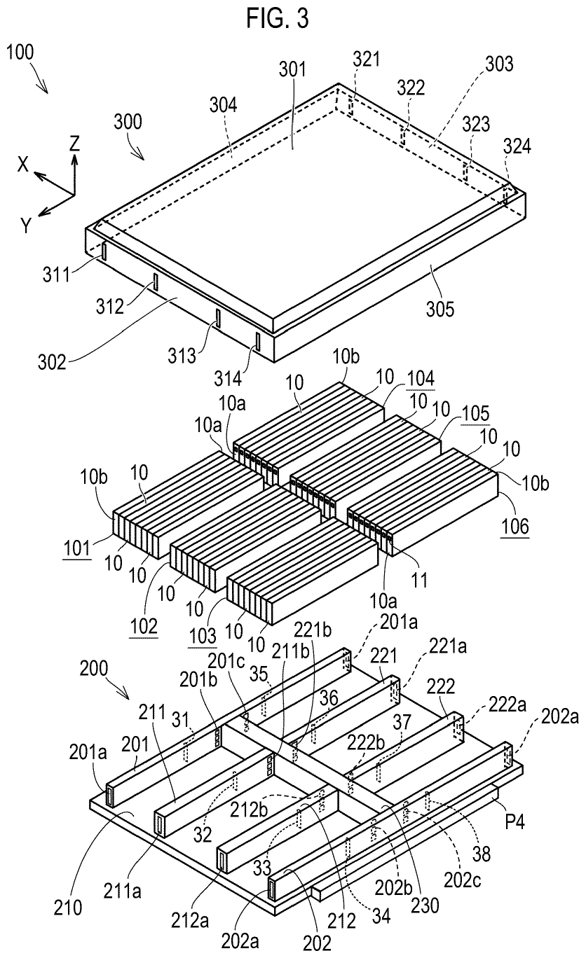

FIG. 3 is an exploded perspective view of the power storage device 100. Note that, in FIG. 3, the component 100a and the undercover 220 are omitted.

As shown in FIG. 3, the UPR case 300 is formed in a box shape that is open on a-Z side. The UPR case 300 functions as a lid for the LWR case 200. The UPR case 300 includes a plate-shaped ceiling portion 301 and wall portions 302 to 305 corresponding to the peripheral wall of the ceiling portion 301. Each of wall portions 302 to 305 protrudes from the ceiling portion 301 to the −Z side. The wall portions 302, 303 face each other in the Y direction. The wall portions 304, 305 face each other in the X direction. The wall portion 302 is provided with discharge ports 311 to 314 that penetrate the wall portion 302. The discharge ports 311, 312, 313, 314 are formed at positions corresponding to the exhaust paths 201a, 211a, 212a, 202a to be described later. The wall portion 303 is provided with discharge ports 321 to 324 that penetrate the wall portion 303. The discharge ports 321, 322, 323, 324 are formed at positions corresponding to the exhaust paths 201a, 221a, 222a, 202a to be described later.

The LWR case 200 includes frame members 201, 202, 211, 212, 221, 222, 230 provided on a +Z side surface of the bottom portion 210. Each frame member protrudes on the +Z side of the bottom portion 210. The frame member 201 is positioned at an end portion of the bottom portion 210 on the +X side. The frame member 202 is positioned at an end portion of the bottom portion 210 on the −X side. Each of the frame members 201, 202 is formed to be long in the Y direction from the +Y side end portion to the −Y side end portion of the bottom portion 210. The frame member 230 is positioned at a substantially middle portion of the bottom portion 210 in the Y direction and between the frame members 201, 202. The frame member 230 is formed to be long in the X direction from the inside (−X side) of the frame member 201 to the inside (+X side) of the frame member 202.

The frame members 211, 212 are provided to divide the +Y side region defined by the frame members 201, 202, 230 into three substantially equal parts. Each of the frame members 211, 212 is formed to be long in the Y direction from the end portion on the +Y side of the bottom portion 210 to the frame member 230. The frame members 221, 222 are provided to divide the region on the −Y side partitioned by the frame members 201, 202, 230 into three substantially equal parts. Each of the frame members 221, 222 is formed to be long in the Y direction from the end portion on the −Y side of the bottom portion 210 to the frame member 230. The frame members 211, 221 face each other in the Y direction with the frame member 230 interposed therebetween. The frame members 212, 222 face each other in the Y direction with the frame member 230 interposed therebetween.

The power storage device 100 includes power storage modules 101 to 106. Each of the power storage modules 101 to 106 functions as a power storage unit of the power storage device 100. Each of the power storage modules 101 to 106 has a structure in which a plurality of power storage cells 10 (for example, eight power storage cells 10) is stacked in the X direction. An electrode body is housed in a case of the power storage cell 10. The electrode body is, for example, a wound body in which a positive electrode sheet and a negative electrode sheet are wound via a separator. For example, one or more wound bodies that function as an electrode body may be housed in a metal rectangular case in a state of being covered with a laminate exterior body. However, the electrode body may be a laminate in which a positive electrode sheet and a negative electrode sheet are laminated via a separator. Each of the positive electrode sheet and the negative electrode sheet includes an electrode foil and an active material layer. The power storage cell 10 is, for example, a secondary battery, such as a lithium ion battery, a nickel-metal hydride battery, or a sodium ion battery. Examples of the lithium-ion battery include a lithium iron phosphate (LFP) battery in which lithium iron phosphate is employed as a positive electrode active material, or a ternary battery in which NMC (nickel, manganese, cobalt) is employed as a positive electrode active material. The type of the secondary battery may be a liquid secondary battery or a solid secondary battery.

The power storage modules 101 to 106 are disposed in six areas partitioned by the frame members. Specifically, the power storage module 101 is located in a first region partitioned by the frame members 201, 211, 230. The power storage module 102 is positioned in a second region partitioned by the frame members 211, 212, 230. The power storage module 103 is located in a third region partitioned by the frame members 212, 202, 230. The power storage module 104 is located in a fourth region partitioned by the frame members 201, 221, 230. The power storage module 105 is located in a fifth region partitioned by the frame members 221, 222, 230. The power storage module 106 is located in a sixth region partitioned by the frame members 222, 202, 230.

The power storage cell 10 has a rectangular parallelepiped shape in which the Y direction is a longitudinal direction. The ratio of the length (dimension in the Y direction) to the width (dimension in the X direction) of the power storage cell 10 may be 4 or more and 25 or less. The width and the length of the power storage cell 10 may be about 50 mm and about 1,000 mm, respectively. In the present embodiment, the height of the power storage cell 10 (dimension in the Z direction) is equal to or less than the height of each frame member. The height of the power storage cell 10 may be about 100 mm.

The power storage cell 10 has a first end surface 10a and a second end surface 10b in a longitudinal direction (Y direction). A first end surface 10a has an exhaust valve 11. The exhaust valve 11 is opened when the internal pressure (pressure in the case) of the power storage cell 10 exceeds a predetermined pressure, and discharges the gas in the case to the outside of the case. In each of the power storage modules 101 to 103, the power storage cells are disposed such that the second end surface 10b faces the +Y side and the first end surface 10a faces the −Y side. In each of the power storage modules 104 to 106, the power storage cells are disposed such that the first end surface 10a faces the +Y side and the second end surface 10b faces the −Y side.

An exhaust path 201a that penetrates the frame member 201 in a Y direction is formed in the frame member 201. The surface of the frame member 201 facing the power storage module 101 (surface on the −X side) is provided with one or more opening portions 201b (for example, three opening portions 201b arranged in the Z direction) connected to the exhaust path 201a. The opening portion 201b is located in the vicinity of the +Y side of the frame member 230. A detection member 31 that closes the exhaust path 201a is further provided on the +Y side of the opening portion 201b. Further, one or more opening portions 201c (for example, three opening portions 201c arranged in the Z direction) that are connected to the exhaust path 201a are formed on a surface of the frame member 201 facing the power storage module 104 (a surface on the −X side). The opening portion 201c is located near the −Y side of the frame member 230. A detection member 35 that closes the exhaust path 201a is further provided on a −Y side of the opening portion 201c.

Inside the frame member 202, an exhaust path 202a penetrating the frame member 202 in the Y direction is formed. The surface of the frame member 202 facing the power storage module 103 (+X side surface) is provided with one or more opening portions 202b (for example, three opening portions 202b arranged in the Z direction) connected to the exhaust path 202a. The opening portion 202b is located in the vicinity of the +Y side of the frame member 230. A detection member 34 that closes the exhaust path 202a is further provided on the +Y side of the opening portion 202b. Further, one or more opening portions 202c (for example, three opening portions 202c arranged in the Z direction) that are connected to the exhaust path 202a are formed on the surface of the frame member 202 facing the power storage module 106 (+X side surface). The opening portion 202c is located near the −Y side of the frame member 230. A detection member 38 that closes the exhaust path 202a is further provided on a −Y side of the opening portion 202c.

Inside the frame members 211, 212, exhaust paths 211a, 212a extending in the Y direction from the end surface on the +Y side to the end portion on the −Y side of the frame members 211, 212 are formed, respectively. Further, one or more opening portions 211b (for example, three opening portions 211b arranged in the Z direction) are further formed at the end portion of the frame member 211 on the −Y side. The opening portion 211b is connected to the exhaust path 211a from a surface of the frame member 211 facing the power storage module 102 (a surface on the −X side). A detection member 32 that closes the exhaust path 211a is further provided on the +Y side of the opening portion 211b. Further, one or more opening portions 212b (for example, three opening portions 212b arranged in the Z direction) are further formed in the end portion of the frame member 212 on the −Y side. The opening portion 212b is connected to the exhaust path 212a from a surface of the frame member 212 facing the power storage module 102 (+X side surface). A detection member 33 that closes the exhaust path 212a is further provided on the +Y side of the opening portion 212b.

Inside the frame members 221, 222, exhaust paths 221a, 222a extending in the Y direction from the end surface on the −Y side to the end portion on the +Y side of the frame members 221, 222 are formed, respectively. Further, one or more opening portions 221b (for example, three opening portions 221b arranged in the Z direction) are further formed in the end portion of the frame member 221 on the +Y side. The opening portion 221b is connected to the exhaust path 221a from a surface of the frame member 221 facing the power storage module 105 (a surface on the −X side). A detection member 36 that closes the exhaust path 221a is further provided on a −Y side of the opening portion 221b. Further, one or more opening portions 222b (for example, three opening portions 222b arranged in the Z direction) are further formed in the end portion of the frame member 222 on the +Y side. The opening portion 222b is connected to the exhaust path 222a from a surface of the frame member 222 facing the power storage module 105 (+X side surface). A detection member 37 that closes the exhaust path 222a is further provided on a-Y side of the opening portion 222b.

The exhaust path 201a is formed to guide the gas discharged from the power storage modules 101, 104 to the discharge ports 311, 321. The exhaust path 202a is formed to guide the gas discharged from the power storage modules 103, 106 to the discharge ports 314, 324. The exhaust paths 211a, 212a are formed to guide the gas discharged from the power storage module 102 to the discharge ports 312, 313, respectively. The exhaust paths 221a, 222a are formed to guide the gas discharged from the power storage module 105 to the discharge ports 322, 323, respectively.

As described above, each of the frame members 201, 202, 211, 212, 221, 222 is formed in a cylindrical shape. On the other hand, the frame member 230 that separates the region on the +Y side and the region on the −Y side of the LWR case 200 does not have an exhaust path. The frame member 230 has a solid structure. As a result, the rigidity of the central portion of the power storage device 100 is improved. Each of the end surfaces of the frame members 211, 212, 221, 222 may be joined (for example, welded) to the frame member 230. In the power storage device 100, a plurality of exhaust paths is assigned to each of the power storage modules 102, 105 located at the center. With this, in the central portion of the power storage device 100, the exhaust is promoted and the temperature rise is suppressed.

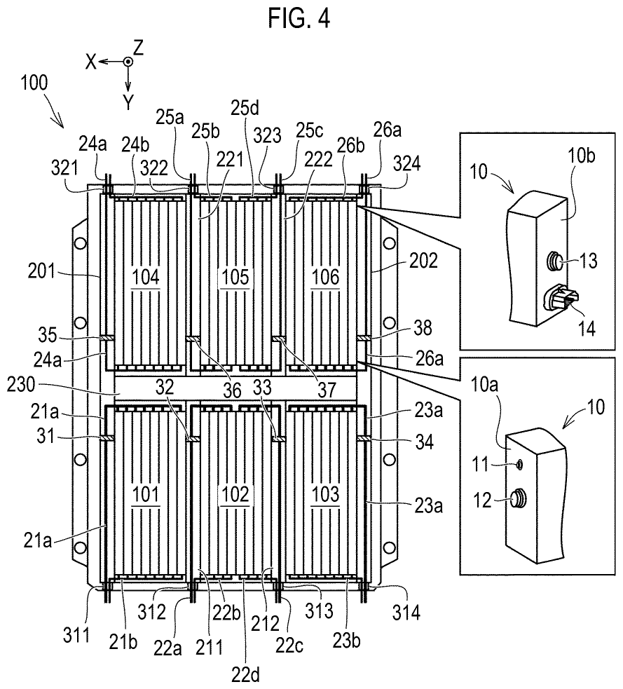

FIG. 4 is a diagram showing an example of a wiring aspect of the power storage device 100. With reference to FIG. 4, an external terminal 12 is provided on the first end surface 10a of the power storage cell 10 in addition to the above-described exhaust valve 11. An external terminal 13 and a connector 14 are provided on the second end surface 10b of the power storage cell 10. Each of the external terminals 12, 13 has an electrode tab that functions as a negative electrode or a positive electrode of the power storage cell 10. An insulating sealing structure made of a ceramic may be formed around the electrode tab. In the present embodiment, the external terminals 12, 13 function as a positive electrode terminal and a negative electrode terminal, respectively. However, the present disclosure is not limited thereto, and the polarity may be reversed, and the external terminal 12 may be a negative electrode terminal and the external terminal 13 may be a positive electrode terminal. The connector 14 includes an output terminal that outputs a detection signal indicating a state in the case detected by one or more sensors in the case (for example, an internal temperature of the power storage cell 10) to the outside of the case. For example, a temperature sensor may be provided for each of the power storage cells in the case. In addition, the connector 14 may further include an input terminal that inputs a control signal to one or more pieces of equipment in the case from the outside of the case.

A first end surface 10a (end surface on the −Y side) of each power storage cell included in the power storage modules 101, 103 is connected to a first line 21a, 23a, respectively. The first lines 21a, 23a extend from the power storage modules 101, 103 to the outside of the housing of the power storage device 100, passing through the opening portions 201b, 202b (FIG. 3) and further passing through the exhaust paths 201a, 202a (FIG. 3), and the discharge ports 311, 314. A second end surface 10b (end surface on the +Y side) of each power storage cell included in the power storage modules 101, 103 is connected to a second line 21b, 23b, respectively. The second lines 21b, 23b extend from the discharge ports 311, 314 of the power storage modules 101, 103 to the outside of the housing of the power storage device 100.

Among the power storage cells 10 included in the power storage module 102, the first end surface 10a and the second end surface 10b of a part of the power storage cells 10 are connected to the first line 22a and the second line 22b, respectively. A first end surface 10a and a second end surface 10b of each of the remaining power storage cells 10 are connected to the first line 22c and the second line 22d, respectively. The first lines 22a, 22c connected to the first end surface 10a (end surface on the −Y side) pass through the opening portions 211b, 212b (FIG. 3) from the power storage module 102, respectively. Further, the first lines 22a, 22c extend to the outside of the housing of the power storage device 100 through the exhaust paths 211a, 212a (FIG. 3) and the discharge ports 312, 313, respectively. Second lines 22b, 22d connected to the second end surface 10b (end surface on the +Y side) extend from the power storage module 102 to the outside of the housing of the power storage device 100 through the discharge ports 312, 313, respectively.

A first end surface 10a (end surface on the +Y side) of each power storage cell included in the power storage modules 104, 106 is connected to a first line 24a, 26a, respectively. The first lines 24a, 26a extend from the power storage modules 104, 106 to the outside of the housing of the power storage device 100, passing through the opening portions 201c, 202c (FIG. 3) and further passing through the exhaust paths 201a, 202a (FIG. 3), and the discharge ports 321, 324. A second end surface 10b (end surface on the −Y side) of each power storage cell included in the power storage modules 104, 106 is connected to the second lines 24b, 26b, respectively. The second lines 24b, 26b extend from the power storage modules 104, 106 to the outside of the housing of the power storage device 100, passing through the discharge ports 321, 324, respectively.

Among the power storage cells 10 included in the power storage module 105, the first end surface 10a and the second end surface 10b of a part of the power storage cells 10 are connected to the first line 25a and the second line 25b, respectively. The first end surface 10a and the second end surface 10b of the remaining power storage cell 10 are connected to the first line 25c and the second line 25d, respectively. The first lines 25a, 25c connected to the first end surface 10a (the end surface on the +Y side) pass through the opening portions 221b, 222b (FIG. 3) from the power storage module 105, respectively. The first lines 25a, 25c further extend to the outside of the housing of the power storage device 100 through the exhaust paths 221a, 222a (FIG. 3) and the discharge ports 322, 323. Second lines 25b, 25d connected to the second end surface 10b (end surface on the −Y side) extend from the power storage module 105 to the outside of the housing of the power storage device 100 through the discharge ports 322, 323, respectively.

Each of the first lines 21a to 26a, 22c, 25c includes a first power line (for example, a power line of the positive electrode) connected to the external terminal 12 of each power storage cell. Each of the second lines 21b to 26b, 22d, 25d includes a second power line (for example, a power line of the negative electrode) connected to the external terminal 13 of each power storage cell and a communication line connected to the connector 14 of each power storage cell.

In the present embodiment, at a first end (the frame member 230 side) of each power storage module, electrodes of adjacent power storage cells having the same polarity (for example, positive electrodes) are electrically connected. In addition, electrodes of the same polarity of adjacent power storage cells (for example, negative electrodes) are electrically connected to each other at a second end (the end on the discharge port 311 to 314 side or the end on the discharge port 321 to 324 side) of each power storage module. As described above, the power storage cells 10 in each power storage module are connected in parallel. However, the present disclosure is not limited thereto, and the power storage cells in each power storage module may be connected in series. For example, a first power storage cell in which the external terminal 12 is a positive electrode and the external terminal 13 is a negative electrode and a second power storage cell in which the external terminal 12 is a negative electrode and the external terminal 13 is a positive electrode may be alternately disposed. Then, the positive electrode and the negative electrode of the adjacent power storage cells may be electrically connected to each other to connect the power storage cells in series. Outside the housing of the power storage device 100, for example, the first power line and the second power line of each of the power storage modules are connected such that the power storage modules 101 to 106 are electrically connected in series. It should be noted that the present disclosure is not limited to this, and the power storage modules 101 to 106 may be electrically connected in parallel.

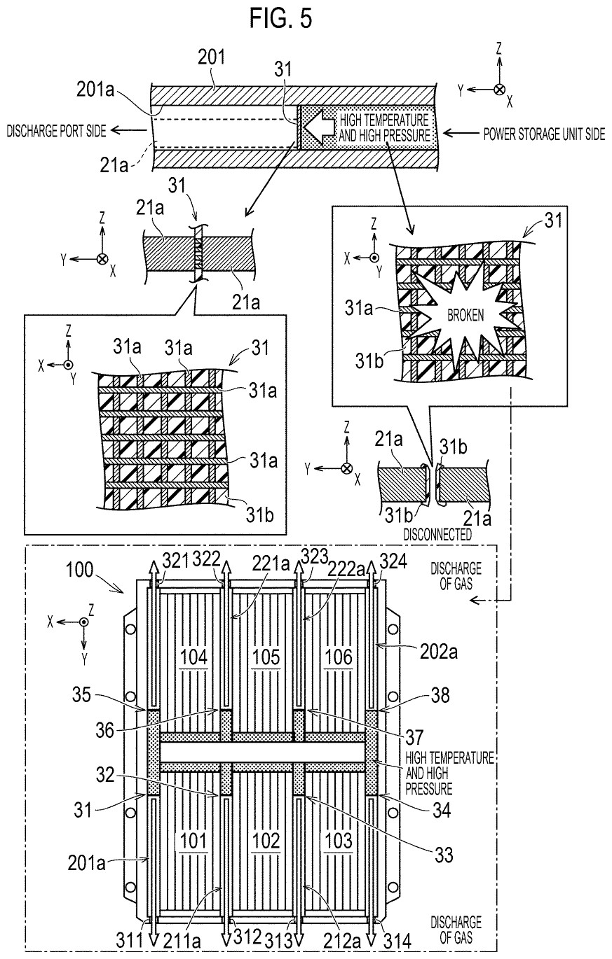

In the present embodiment, the detection members 32, 33, 36, 37 are provided in the exhaust paths 211a, 212a, 221a, 222a, respectively. The detection members 31, 35 are provided in the first lines 21a, 24a in the exhaust path 201a, respectively. The detection members 34, 38 are provided in the first lines 23a, 26a in the exhaust path 202a, respectively. Each of the detection members 31 to 38 is disposed at a position closer to the power storage unit (power storage modules 101 to 106) than the discharge ports 311 to 314, 321 to 324. Each of the detection members blocks the corresponding exhaust path and functions as a fuse of a first power line disposed in the corresponding exhaust path. Specifically, each detection member has a structure shown in FIG. 5 described below.

FIG. 5 is a diagram showing an example of a structure of a detection member. With reference to FIG. 5, the detection member 31 is a blocking member provided to block the exhaust path 201a. The detection member 31 is formed in a film shape. The detection member 31 includes a plurality of conductor lines 31a (fuse lines) formed in a lattice shape and a resin 31b that fills the gaps between the conductor wires. Each of the conductor lines functions as a core material of the film. The conductor line 31a and the resin 31b melt due to the heat of the gas. When the conductor line 31a melts, the strength of the detection member 31 is weakened. Then, the detection member 31 is broken by the pressure of the gas. The strength of the detection member 31 is appropriately set to be weak such that the detection member 31 is broken by the increase in pressure before the pressure of the gas exceeds the allowable value. The strength of the detection member 31 may be adjusted by the thickness of the conductor line 31a.

The detection member 31 is provided in the middle of the first line 21a (first power line) and functions as a fuse. The conductor line 31a corresponds to a fuse line provided in the first power line connected to the power storage module 101. The conductor line 31a is configured to be melted by the heat of the gas discharged from the power storage module 101. When the detection member 31 is not broken, the first line 21a is in a conductive state. Since each exhaust path is blocked by the detection members 31 to 38, the gas discharged from the exhaust valve 11 of each power storage cell is accumulated in the central portion of the power storage device 100 (the space near the frame member 230 blocked by the detection members 31 to 38). In addition, as the amount of the gas increases, the gas becomes high in temperature and high in pressure. When the detection member 31 is melted and broken by the high-temperature and high-pressure gas, the first line 21a is in a disconnected state (cut-off state). The cut portion of the first line 21a is insulated by the melted resin 31b. The exhaust path 201a is opened by the breaking of the detection member 31, and the high-temperature and high-pressure gas is discharged to the outside from the discharge port 311 through the exhaust path 201a.

Although FIG. 5 shows solely the structure around the detection member 31 as a representative, other detection members (detection members 32 to 38) also have the same structure as the detection member 31. Even when the other detection member is broken, the high-temperature and high-pressure gas is discharged to the outside of the housing of the power storage device 100. Since each of the detection members 31 to 38 is disposed at a position closer to the power storage unit than the discharge port on the path of the gas flowing through the corresponding exhaust path, each detection member is likely to be broken before the amount of gas discharged from the power storage unit exceeds the allowable value. The high-temperature and high-pressure gas is discharged to the outside through the corresponding discharge port via the corresponding exhaust path. The discharged gas may be guided to a predetermined place by a duct provided outside the housing. In addition, an exhaust valve may be provided in each of the discharge ports 311 to 314 and 321 to 324.

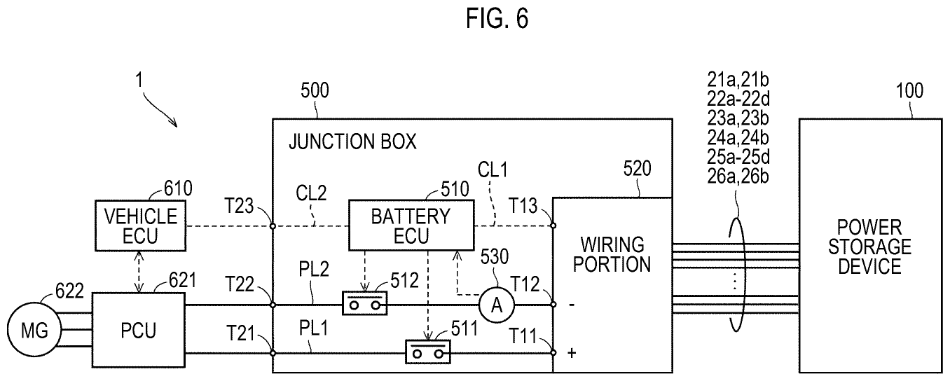

The power storage device 100 may be connected to a drive system of the vehicle 1 via a junction box. FIG. 6 is a diagram for describing a system according to the present embodiment.

With reference to FIG. 6 together with FIGS. 1 and 2, the vehicle 1 further includes a J/B 500. The J/B 500 includes a battery ECU 510, relays 511, 512, a wiring portion 520, and a current sensor 530. Each of the relays 511, 512 may be an electromagnetic mechanical relay. The drive system of the vehicle 1 includes a drive device (for example, the PCU 621 and the MG 622) that causes the vehicle 1 to travel by using the electric power supplied from the power storage device 100, and a control device (for example, the vehicle ECU 610) that controls the drive device. Note that “J/B” means a junction box, “ECU” means an electronic control unit, “PCU” means a power control unit, and “MG” means a motor generator.

The first lines 21a to 26a, 22c, 25c and the second lines 21b to 26b, 22d, 25d that are taken out of the housing of the power storage device 100 are connected to the wiring portion 520 of the J/B 500. Further, a signal line (communication line not shown) of a sensor (for example, a temperature sensor) included in the component 100a (FIG. 2) may be connected to the wiring portion 520. The wiring portion 520 is wired such that various connected wires are three wires, specifically, a total plus line, a total minus line, and a communication line. The total plus line outputs a total electric potential of positive electrodes of all the power storage modules. The total minus line outputs the total electric potential of the negative electrodes of all the power storage modules. The communication line is connected to be communicable with each power storage cell. The wiring portion 520 includes terminals T11, T12, T13 to which the total plus line, the total minus line, and the communication line are connected, respectively. In addition, the J/B 500 further includes terminals T21 to T23.

The terminal T11 is connected to the terminal T21 via the power line PL1. The terminal T12 is connected to the terminal T22 via a power line PL2. The relays 511, 512 are provided in the power lines PL1, PL2, respectively. Each of the relays 511, 512 is controlled by the battery ECU 510. In addition, the current sensor 530 detects a current flowing through the power line PL2 between the relay 512 and the terminal T12, and outputs a detection result to the battery ECU 510.

The terminal T13 is connected to the battery ECU 510 via a communication line CL1. The terminal T13 outputs, for example, information inside each power storage cell (for example, temperature information) sent from the connector 14 of each storage cell to the battery ECU 510. In addition, the terminal T13 may output the information (for example, temperature information) on the outside of the cell transmitted from the component 100a to the battery ECU 510. In a normal state, the battery ECU 510 sets each of the relays 511, 512 to a connection state (closed state). As a result, each of the power lines PL1, PL2 is in a conductive state. On the other hand, in a case where the abnormality is detected, the battery ECU 510 turns at least one of the relays 511, 512 into the cutoff state (open state). By turning at least one of the relays 511, 512 into the interruption state when the abnormality occurs, the power supply by the power storage device 100 can be stopped.

In the present embodiment, the battery ECU 510 determines whether or not the high-temperature and high-pressure gas is generated in the space closed by the detection members 31 to 38 based on whether or not at least one of the detection members 31 to 38 is broken. Then, in a case where the determination is made that the high-temperature and high-pressure gas is generated, the battery ECU 510 turns off at least one of the relays 511, 512. For example, in a case where at least one of the detection members 31 to 38 is broken, the abnormal current value is detected by the current sensor 530 due to the disconnection of the power line. For example, in a case where the amount of decrease in the current detected by the current sensor 530 is equal to or greater than a predetermined value during the powering of the MG 622, the battery ECU 510 may determine that at least one of the detection members 31 to 38 is broken. The battery ECU 510 may turn at least one of the relays 511, 512 into the cutoff state when the temperature inside the cell or the temperature outside the cell exceeds the allowable value.

The battery ECU 510 is connected to the terminal T23 via a communication line CL2. The vehicle ECU 610 positioned outside the J/B 500 is connected to the terminal T23 via a communication line. The vehicle ECU 610 and the battery ECU 510 are connected to be communicable with each other. The vehicle ECU 610 acquires information on the power storage device 100 from the battery ECU 510. The vehicle ECU 610 controls the PCU 621 based on the state of the power storage device 100.

The PCU 621 is connected to the terminals T21, T22 via the power line. The power storage device 100 is configured to supply the electric power to the PCU 621 via the J/B 500. The PCU 621 drives the MG 622 by using the electric power supplied from the power storage device 100. The PCU 621 includes, for example, an inverter. The MG622 functions as a drive motor and rotates drive wheels of the vehicle 1. In addition, the MG622 performs regenerative electric power generation, for example, at the time of deceleration of the vehicle 1 to charge the power storage device 100. However, in a case where the power line is cut off by the J/B 500, the power is not exchanged between the power storage device 100 and the drive device (PCU 621 and MG 622) of the vehicle 1.

As described above, the power storage device 100 according to the present embodiment includes a housing (LWR case 200 and UPR case 300) and a power storage unit (power storage modules 101 to 106) housed in the housing. The housing includes frame members 201, 202, 211, 212, 221, 222 in which exhaust paths 201a, 202a, 211a, 212a, 221a, 222a that guide the gas discharged from the power storage unit to the outside of the housing are respectively formed. In each of the exhaust paths 201a, 202a, 211a, 212a, 221a, 222a, a blocking member (detection members 31 to 38) is provided to block the corresponding exhaust path. Each of the detection members 31 to 38 is configured to be broken by a pressure increase due to the gas discharged from the power storage unit. In the power storage device 100, the blocking member (the detection members 31 to 38) that blocks the exhaust path is physically broken when the high-temperature and high-pressure gas is generated, and the exhaust path is opened. The physical disconnection of the power line in an environment in which the gas exceeding the allowable capacity is generated suppresses the power supply by the power storage device 100 in a case where the high-temperature and high-pressure gas is generated. Even when the temperature sensor fails, the exhaust path is opened and the power line is cut off. Therefore, it is possible to more reliably open the exhaust path and cut off the power line when the high-temperature and high-pressure gas is generated.

The system according to the present embodiment is mounted on the vehicle 1, and includes the power storage device 100 and the control device (battery ECU 510 and vehicle ECU 610). The battery ECU 510 is configured to determine whether or not the gas is generated in the space closed by the blocking member based on whether or not the blocking member (the detection members 31 to 38) is broken. According to such a system, it is easy to accurately detect the generation of the gas.

The embodiment disclosed herein is merely illustrative and not restrictive in all respects. The scope of the disclosure is defined not by the detailed description of embodiments but by the claims, and is intended to cover all equivalents and all modifications within the scope of the claims.

What is claimed is:

1. A power storage device comprising:
a housing including a frame member; and
a power storage unit housed in the housing, wherein:
an exhaust path configured to guide a gas discharged from the power storage unit to an outside of the housing is provided in the frame member;
the exhaust path is provided with a blocking member configured to block the exhaust path; and
the blocking member is configured to be broken by an increase in a pressure due to the gas discharged from the power storage unit.

2. The power storage device according to claim 1, wherein:
the blocking member includes fuse lines provided in a power line connected to the power storage unit; and
the fuse lines are configured to be melted by heat of the gas discharged from the power storage unit.

3. The power storage device according to claim 2, wherein:
the blocking member further includes resin; and
the fuse lines are provided in a lattice shape and the resin is provided to fill gaps between the fuse lines in the lattice shape, in the blocking member.

4. The power storage device according to claim 1, wherein:
a discharge port is provided in the housing;
the exhaust path is configured to guide the gas discharged from the power storage unit to the discharge port; and
the blocking member is disposed at a position closer to the power storage unit than the discharge port, on a path of the gas flowing through the exhaust path.

5. A system comprising:
the power storage device according to any one of claim 1; and
a control device, wherein
the control device is configured to determine whether a gas is generated in a space blocked by the blocking member based on whether the blocking member is broken.
